(19) United States
(12) Patent Application Publication
(10) Pub. No.: US 2023/0259954 A1
(43) Pub. Date: Aug. 17, 2023

(54) METHOD AND APPARATUS FOR FACILITATING CUSTOMER-AGENT INTERACTIONS USING AUGMENTED REALITY

(71) Applicant: [24]7 .ai. Inc., Campbell, CA (US)

(72) Inventor: Manoj Rajshekar, Fremont, CA (US)

(21) Appl. No.: 18/171,038

(22) Filed: Feb. 17, 2023

Related U.S. Application Data
(60) Provisional application No. 63/268,160, filed on Feb. 17, 2022.

(51) Int. Cl. G06Q 30/016; G06T 19/00; G06V 10/74; H04N 5/265; G06Q 30/02

(52) U.S. Cl. CPC G06Q 30/016; G06T 19/006; G06V 10/761; H04N 5/265; G06Q 30/02

(57) ABSTRACT

Methods and systems for facilitating user-agent interactions using augmented reality (AR) are disclosed. Method includes facilitating interaction between user and agent upon receiving request from user. Method includes receiving AR-based workflow including set of instructions from agent. Method includes receiving viewfinder frame from electronic device associated with user subsequent to initializing AR session in response to executing a first instruction from set of instructions. Method includes iteratively performing plurality of operations till each instruction from set of instructions is executed, plurality of operations includes analyzing viewfinder frame to determine subsequent instruction to be executed from set of instructions. Then, facilitate display of AR image frame. AR image frame is generated based on subsequent instruction. Further, determine execution status of the subsequent instruction by monitoring user while user executes the subsequent instruction. The execution status indicates whether subsequent instruction is successful or unsuccessful. Further, transmit notification indicating execution status to agent.

### CROSS REFERENCE TO RELATED APPLICATIONS

This application claims the benefit of U.S. Provisional Application No. 63/268,160, filed Feb. 17, 2022, and the contents of which is incorporated by reference herein in its entirety.

### TECHNICAL FIELD

The present technology generally relates to interactions between users such as customers and agents of an enterprise and, more particularly, to a method and apparatus for facilitating customer-agent interactions using augmented reality (AR).

### BACKGROUND

In many scenarios, users such as customers of an enterprise may wish to converse with customer support representatives (hereinafter referred to as ‘agents’) of the enterprise to enquire about products/services of interest, to resolve concerns, to make payments, to lodge complaints, and the like. To provide the users with the desired assistance, enterprises may deploy human agents and automated/virtual agents as customer support representatives. The agents may be trained to interact with the users and, in general, provide desired assistance to the users. The user-agent interactions may be conducted over various interaction channels, such as a voice channel (for example, over a phone call), a chat channel (for example, using an instant messaging application), a social media channel, a native mobile application channel, and the like.

Sometimes, an agent may request a user to perform a series of steps to resolve a user issue. In an illustrative example, a user may wish to troubleshoot a connectivity issue associated with a wireless router purchased from an enterprise. The solution to such an issue may involve reconfiguring the wireless router. In an example scenario, reconfiguration of the wireless router may involve a series of steps, such as, rebooting the router, accessing a configuration page, manipulating the data on the configuration page, manually selecting preference options, and the like. An agent may provide step-by-step instructions to provide the desired assistance to the user. However, the user may misinterpret a step and the issue may not be resolved properly. Moreover, the agent may not be aware if the user has accurately followed the sequence of steps. For example, rebooting the wireless router may involve the steps of locating a reset button on the router, pressing the reset button for a few seconds, and waiting for a blinking light to become steady. In some cases, the user may not be aware of the reset button on the wireless router and may switch the power button ON and OFF in response to the agent's instruction to reset the wireless router. In such a scenario, the user may face issues while executing the subsequent steps and the user issue may not get resolved. This may cause the interaction between the user and the agent to continue back-and-forth and the resolution may not be successful till the agent is aware that the user has not followed the step of resetting the wireless router. The user may get frustrated on account of the back-and-forth communication and, in some cases, exit the interaction. Such negative user experiences may result in loss of business for the enterprise.

Accordingly, there is a need to assist the agents in addressing the needs of the users and in providing a satisfying user experience. It would also be advantageous to enable the agents to learn if individual instructions are being correctly followed by the users and provide course correction wherever required.

### SUMMARY

A computer-implemented method is disclosed. The method performed by the processing system includes facilitating an interaction between a user and an agent upon receiving a request for initiating an interaction from the user. Further, the method incudes receiving an augmented reality (AR)-based workflow including a set of instructions from the agent. Herein, the agent selects the AR-based workflow from a plurality of AR-based workflows based, at least in part, on interpreting a user objective for initiating the interaction. Further, the method incudes receiving a viewfinder frame from an electronic device associated with the user subsequent to initializing an AR session by the user in response to executing a first instruction from the set of instructions. Further, the method incudes iteratively performing a plurality of operations till each instruction from the set of instructions is executed. The plurality of operations includes electronically analyzing the viewfinder frame to determine a subsequent instruction to be executed by the user from the set of instructions. Then, facilitate a display of an AR image frame on the electronic device. Herein, the AR image frame is generated based, at least in part, on the subsequent instruction. Further, determine an execution status of the subsequent instruction by monitoring the user while the user executes the subsequent instruction. Herein, the execution status indicates whether the subsequent instruction is one of successful and unsuccessful. Furthermore, transmit a notification indicating the execution status to the agent.

An apparatus including at least one processor and a memory having stored therein machine-executable instructions is disclosed. The machine-executable instructions, executed by the at least one processor, cause the apparatus to facilitate an interaction between a user and an agent upon receiving a request for initiating an interaction from the user. Further, the apparatus is caused to receive an augmented reality (AR)-based workflow including a set of instructions from the agent. Herein, the agent selects the AR-based workflow from a plurality of AR-based workflows based, at least in part, on interpreting a user objective for initiating the interaction. Further, the apparatus is caused to receive a viewfinder frame from an electronic device associated with the user subsequent to initializing an AR session by the user in response to executing a first instruction from the set of instructions. Further, the apparatus is caused to iteratively perform a plurality of operations till each instruction from the set of instructions is executed. The plurality of operations includes electronically analyzing the viewfinder frame to determine a subsequent instruction to be executed by the user from the set of instructions. Then, facilitate a display of an AR image frame on the electronic device. Herein, the AR image frame is generated based, at least in part, on the subsequent instruction. Further, determine an execution status of the subsequent instruction by monitoring the user while the user executes the subsequent instruction. Herein, the execution status indicates whether the subsequent instruction is one of successful and unsuccessful. Furthermore, transmit a notification indicating the execution status to the agent.

A non-transitory computer-readable storage medium is disclosed. The non-transitory computer-readable storage medium includes computer-executable instructions that, when executed by at least a processor of an apparatus, cause the system to perform a method. The method includes facilitating an interaction between a user and an agent upon receiving a request for initiating an interaction from the user. Further, the method incudes receiving an augmented reality (AR)-based workflow including a set of instructions from the agent. Herein, the agent selects the AR-based workflow from a plurality of AR-based workflows based, at least in part, on interpreting a user objective for initiating the interaction. Further, the method incudes receiving a viewfinder frame from an electronic device associated with the user subsequent to initializing an AR session by the user in response to executing a first instruction from the set of instructions. Further, the method incudes iteratively performing a plurality of operations till each instruction from the set of instructions is executed. The plurality of operations includes electronically analyzing the viewfinder frame to determine a subsequent instruction to be executed by the user from the set of instructions. Then, facilitate a display of an AR image frame on the electronic device. Herein, the AR image frame is generated based, at least in part, on the subsequent instruction. Further, determine an execution status of the subsequent instruction by monitoring the user while the user executes the subsequent instruction. Herein, the execution status indicates whether the subsequent instruction is one of successful and unsuccessful. Furthermore, transmit a notification indicating the execution status to the agent.

### BRIEF DESCRIPTION OF THE DRAWINGS

The advantages and features of the invention will become better understood with reference to the detailed description taken in conjunction with the accompanying drawings, wherein like elements are identified with like symbols, and in which:

FIG. 1 shows an example representation of an environment in which various embodiments of the present invention may be practiced;

FIG. 2 is a block diagram of an apparatus configured to facilitate customer-agent interactions using augmented reality (AR), in accordance with an example embodiment;

FIG. 3A shows a representation for illustrating the use of AR in facilitating customer-agent interactions, in accordance with an example embodiment;

FIG. 3B is a representation showing the customer pointing a device camera to a TV remote in response to an agent's instruction, in accordance with an example embodiment;

FIG. 3C shows a representation for illustrating a comparison of the viewfinder frame of the TV remote with a plurality of images of TV remotes, in accordance with an example embodiment;

FIG. 3D shows an example AR image frame content displayed on a display screen of the device of the customer, in accordance with an example embodiment;

FIG. 3E shows an example representation of an agent console for illustrating the notifications provided by the apparatus of FIG. 2, in accordance with an example embodiment;

FIG. 4A shows a representation for illustrating the use of AR for facilitating customer-agent interactions, in accordance with another example embodiment;

FIG. 4B is a representation showing the customer pointing a device camera to a personal computer in response to the instruction associated with an AR-based workflow, in accordance with an example embodiment;

FIG. 5 shows a sequence flow for illustrating the facilitation of customer-agent interactions using AR, in accordance with an example embodiment;

FIG. 6 shows a flow diagram of a method for facilitating customer-agent interactions using AR, in accordance with an example embodiment; and

FIG. 7 shows a flow diagram of a method for facilitating an interaction between a user and an agent using AR, in accordance with an example embodiment.

The drawings referred to in this description are not to be understood as being drawn to scale except if specifically noted, and such drawings are only exemplary in nature.

### DETAILED DESCRIPTION

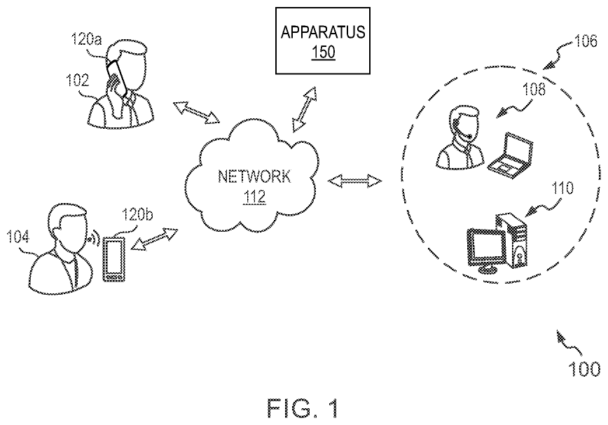

The best and other modes for carrying out the present invention are presented in terms of the embodiments, herein depicted in FIGS. 1 to 7. The embodiments are described herein for illustrative purposes and are subject to many variations. It is understood that various omissions and substitutions of equivalents are contemplated as circumstances may suggest or render expedient but are intended to cover the application or implementation without departing from the spirit or scope of the invention. Further, it is to be understood that the phraseology and terminology employed herein are for the purpose of the description and should not be regarded as limiting. Any heading utilized within this description is for convenience only and has no legal or limiting effect.

The terms “a” and “an” herein do not denote a limitation of quantity, but rather denote the presence of at least one of the referenced items.

FIG. 1 shows an example representation of an environment 100 in which various embodiments of the present invention may be practiced. The environment 100 is depicted to include users (hereinafter referred to interchangeably as ‘customers’) of an enterprise, such as for example customers 102 and 104. The term ‘enterprise’ as used herein may refer to a corporation, an institution, a small/medium sized company, or even a brick-and-mortar entity. For example, the enterprise may be a banking enterprise, an educational institution, a financial trading enterprise, an aviation company, a consumer goods enterprise, or any such public or private sector enterprise. It is understood that the enterprise may be associated with potential and existing users of products, services and/or information offered by the enterprise. Such existing or potential users of enterprise offerings are referred to herein as customers of the enterprise. The environment 100 is depicted to display only two customers for illustration purposes and it is understood that the enterprise may be associated with a large number of potential and existing customers.

Most enterprises, nowadays, extend dedicated customer service and support (CSS) facility to their customers. A typical CSS center includes a number of customer service representatives, such as human agents, chat bots, self-assist systems, such as either Web or mobile digital self-service, and/or interactive voice response (IVR) systems. The customer support representatives are trained to interact with the customers for providing information to the customers, selling to them, answering their queries, addressing their concerns, and/or resolving their issues. The environment 100 depicts an exemplary CSS center 106. The CSS center 106 is depicted to include two customer support representatives in form of a human agent 108 and a virtual agent 110 for illustration purposes. It is understood that the CSS center 106 may include several human and virtual agents for assisting customers of an enterprise with their respective queries.

The customers 102 and 104 are depicted to be associated with smart electronic devices, such as an electronic device 120a and an electronic device 120b, respectively. The smart electronic devices, such as the electronic device 120a and the electronic device 120b, may be equipped with a camera and augmented reality (AR) kits. The electronic device 120a and the electronic device 120b, are collectively referred to hereinafter as electronic devices and individually referred to hereinafter as an electronic device. Some non-exhaustive examples of electronic devices may include a smart phone, a tablet device, a wearable device, and the like. The electronic device is configured to facilitate customer communication with customer support representatives of an enterprise over a communication network, such as network 112. The network 112 may include wired networks, wireless networks, and combinations thereof. Some examples of wired networks may include Ethernet, local area networks (LAN), fiber-optic cable networks, and the like. Some examples of wireless networks may include cellular networks like GSM/3G/4G/5G/CDMA networks, wireless LANs, Bluetooth or Zigbee networks, and the like. An example of a combination of wired and wireless networks may include the Internet.

Typically, a user such as customer 102 may wish to converse with an agent such as human agent 108 of an enterprise to enquire about products/services of interest, to resolve concerns, to make payments, to lodge complaints, and the like. In many example scenarios, for providing resolution to customer issues, the agents may request the customers to perform a series of steps. For example, the agent may provide step-by-step instructions to a customer to provide the desired assistance to the customer 102. However, the customer 102 may misinterpret a step and the issue may not be resolved properly. Moreover, the agent may not be aware if the customer 102 has accurately followed the sequence of steps or not. If the customer 102 has not followed a step correctly, the customer 102 may face issues while executing the subsequent steps and the customer issue may not get resolved. This may cause the interaction between the customer 102 and the agent to continue back-and-forth.

In an illustrative example, the customer 102 may have purchased a do-it-yourself (DIY) coffee table from an online furniture retailer ‘ABC’. On facing difficulty in assembling the furniture, the customer 102 may wish to seek assistance from an agent associated with the enterprise ABC. Accordingly, the customer 102 may initiate a telephonic interaction with the human agent 108 using the electronic device 120a. The customer 102 may share the details of the coffee table (for example, product type, product number, etc.) with the human agent 108. The human agent 108 may then proceed to provide step-by-step instructions for assembling the coffee table. The instructions may include placing a surface of the coffee table top in a downwards manner, inserting upper end of legs in holes present in a bottom portion of the coffee table top by placing a gasket onto threaded stem of the legs, inserting the threaded stem at each corner of the bottom of the table top, tightening by turning the legs clockwise, etc. In many example scenarios, the customer 102 may not follow some of the agent's instructions. For example, the customer 102 may not understand the various nuts and bolts that are needed to fasten the legs to the bottom of the coffee table top. Selecting the incorrect nut/bolt may cause an issue in the subsequent steps of the assembling process and the customer 102 may have to repeat the entire assembling procedure again. The human agent 108 may also have to repeat the entire set of instructions to assist the customer 102 in assembling the coffee table. A customer experience may get ruined on account of the back-and-forth communication and the hardship faced by the customer 102 in assembling the coffee table. Further, in such scenarios, the human agent 108 may also get confused about the exact mistake that was done by the customer 102 thus leading to longer resolution time and poor customer experience. In some cases, the customer 102 may not purchase furniture from the online furniture retailer again leading to a loss of revenue for the enterprise.

In another illustrative example, the customer 104 may have trouble in capturing a screenshot of content being displayed on the display screen of the electronic device 120b. It may happen that a separate screenshot button may not be available on the keypad of the electronic device 120b. Accordingly, the customer 104 may initiate a chat interaction with the virtual agent 110 to request assistance from the virtual agent 110. The virtual agent 110 may be trained to ask questions related to the type and make of the electronic device 120b. Based on the responses provided by the customer 104, the virtual agent 110 may identify a device manufacturer and the keypad associated with the electronic device 120b. The virtual agent 110 may then provide a command sequence to enable the customer 104 to take the screenshot based on the details provided by the customer 104. For example, the customer 104 may be required to simultaneously select/press more than one button in the keypad of the electronic device 120b. However, the customer 104 may not be aware of a particular button or may press the wrong buttons simultaneously and, as a result, the customer 104 may not be able to take the screenshot. In such scenario, an experience of the customer 104 may get adversely affected.

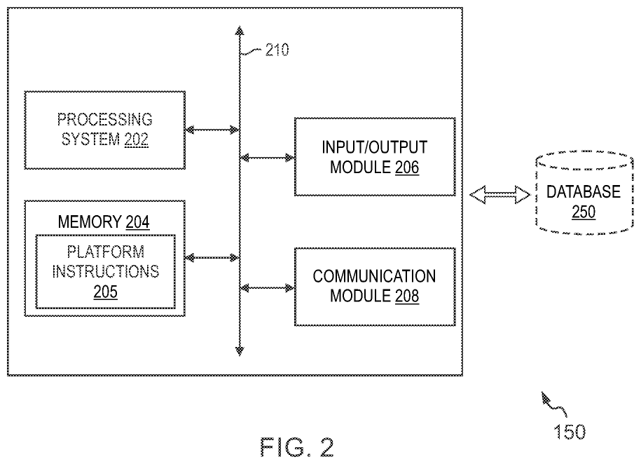

To overcome the above obstacles and provide additional advantages, an apparatus 150 capable of facilitating user-agent interactions is disclosed. In at least one example embodiment, the apparatus 150 is configured to be in operative communication with the CSS center 106. On account of being in operative communication with the CSS center 106, the apparatus 150 is configured to be notified when every customer contacts the CSS center 106 to seek assistance from the agents. More specifically, when a customer calls a customer service number or initiates a chat interaction with an agent by sharing a request for initiating an interaction to the CSS center 106, the apparatus 150 is configured to detect such an event in substantially real-time. The apparatus 150 is also configured to facilitate the triggering of an augmented reality (AR) application in the customer's device. The AR application in the customer's device is leveraged by the apparatus 150 to facilitate customer-agent interactions as will be explained in further detail with reference to FIG. 2.

FIG. 2 is a block diagram of the apparatus 150 configured to facilitate customer-agent interactions using augmented reality (AR), in accordance with an example embodiment. The term ‘user-agent interactions’ or ‘customer-agent interactions’ as used herein refers to conversations, such as voice conversations or chat conversations, between customers and agents of an enterprise. It is noted that the interactions between customers and agents of the enterprise may not be limited to interactions initiated by the customers of the enterprise. In some example cases, the agents of the enterprise may initiate the interactions with the customers. Further, it is noted that the term ‘agents’ as used herein and throughout the description may refer to automated conversational agents (or virtual agents) or to human agents. Further, it is noted that automated conversational agents include chatbots (i.e., automated agents configured to assist customers using textual chat conversation medium) and Interactive Voice Response (IVR) systems (i.e., automated agents configured to assist customers using speech medium). The automated conversational agents are hereinafter referred to as Virtual Agents (VAs). Furthermore, the term ‘facilitating customer-agent interactions using AR’ as used throughout the description implies leveraging AR though various known methods such as via an application installed in electronic devices associated with the users during user-agent interactions to enable the agents to guide the users and provide the desired assistance to the users.

In one embodiment, the apparatus 150 is embodied as an interaction platform. Further, one or more components of the interaction platform may be implemented as a set of software layers on top of existing hardware systems. The interaction platform may be communicably coupled, over a communication network (such as the network 112 shown in FIG. 1), with interaction channels and/or data-gathering Web servers linked to the interaction channels to receive information related to customer-agent interactions in an ongoing manner in substantially real-time. Further, the interaction platform is in operative communication with VAs and electronic devices of the human agents of one or more enterprises and configured to receive information related to customer-agent interactions from them.

The apparatus 150 includes at least a processing system 202 including at least one processor and a memory 204. It is noted that the processing system 202 of the apparatus 150 may include a greater number of processors therein. In an embodiment, the memory 204 is capable of storing machine executable instructions, referred to herein as platform instructions 205. Further, the processing system 202 is capable of executing the platform instructions 205. In an embodiment, the processing system 202 may be embodied as a multi-core processor, a single core processor, or a combination of one or more multi-core processors and one or more single core processors. For example, the processing system 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processing system 202 may be configured to execute hard-coded functionality. In an embodiment, the processing system 202 is embodied as an executor of software instructions, wherein the instructions may specifically configure the processing system 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash memory, RAM (random access memory), etc.), magnetic storage devices (such as hard disk drives, floppy disks, magnetic tapes, etc.), optical magnetic storage devices (e.g., magneto-optical disks), CD-ROM (compact disc read-only memory), CD-R (compact disc recordable), CD-RAN (compact disc rewritable), DVD (Digital Versatile Disc) and BD (BLU-RAY® Disc).

In at least some embodiments, the memory 204 stores instructions for initializing an augmented reality (AR) session by the user in remote devices, such as electronic devices of users. In one example, the AR session is initialized by triggering of an augmented reality (AR) application in remote devices. Further, the memory 204 stores logic for the selection AR-based workflow-based workflow from the agent. In particular, the agent may select the AR-based workflow from a plurality of AR-based workflows based, at least in part, on interpreting a user objective for initiating the interaction. The AR-based workflow further includes a set of instructions for addressing the user objective. For example, the set of instructions may be followed by the user to address their concerns regarding a product due to which they initiated the interaction. Further, the selection of an appropriate AR-based workflow for a user along with logic for personalization or customization of instructions associated with the selected workflow, as will be explained in further detail later. The memory 204 is also configured to store logic for receiving a viewfinder frame from the electronic device associated with the user subsequent to initializing an AR session by the user in response to executing a first instruction from the set of instructions.

Further, the memory 204 is also configured to store logic for analyzing a viewfinder frame to determine a subsequent instruction to be executed by the user from the set of instructions. In particular, at first a plurality of images from a database (such as database 250) is associated with the processing system 202. Then, the viewfinder frame is compared with a plurality of images. Upon determining a match between the viewfinder and an image from the plurality of images, the subsequent instruction from the set of instructions is determined based on the image. For example, if the viewfinder frame is a remote control of a TV, then the viewfinder is compared with a plurality of images of the various products of the enterprise. Upon detecting an image of a remote control similar/same as the remote control in the viewfinder frame, the processing system 150 is configured to a subsequent instruction such as ‘please press the power button’ from a set of instructions such as ‘please grab the remote control’, ‘please press the power button’, ‘please use navigation keys to change channels’, ‘please press the volume button to increase the volume’ and the like. Further, the memory 204 is also configured to store logic for enabling further customization of the AR-based workflow and the corresponding instructions based on the result of the comparison. Further, the memory 204 also includes logic for a display of an AR image frame on a display screen of the electronic devices of the customers to guide the customers towards the resolution of their respective concerns, providing an enriched AR experience to the users. The AR image frame is generated based, at least in part, on the identified instructions (subsequent instruction). In particular, the logic overlays the identified instructions (such as the subsequent instruction) on the viewfinder frame to generate or configure AR image frame content. In some embodiments, the memory 204 stores logic for determining an execution status of the subsequent instruction by monitoring the user while the user executes the subsequent instruction. The execution status indicates whether the subsequent instruction is one of successful or unsuccessful. Further, logic is stored in the memory 204 for notifying the agents such as via transmitting a notification indicating the execution status of the instructions provided to the users. More specifically, the agents may be notified if individual instructions were correctly followed by the user or not.

The apparatus 150 also includes an input/output module 206 (hereinafter referred to as an ‘I/O module 206’) and at least one communication module such as a communication module 208. In an embodiment, the I/O module 206 may include mechanisms configured to receive inputs from and provide outputs to the user of the apparatus 150. To that effect, the I/O module 206 may include at least one input interface and/or at least one output interface. Examples of the input interface may include but are not limited to, a keyboard, a mouse, a joystick, a keypad, a touch screen, soft keys, a microphone, and the like. Examples of the output interface may include, but are not limited to, a display such as a light-emitting diode display, a thin-film transistor (TFT) display, a liquid crystal display, an active-matrix organic light-emitting diode (AMOLED) display, a microphone, a speaker, a ringer, a vibrator, and the like.

In an example embodiment, the processing system 202 may include I/O circuitry configured to control at least some functions of one or more elements of the I/O module 206, such as, for example, a speaker, a microphone, a display, and/or the like. The processing system 202 and/or the I/O circuitry may be configured to control one or more functions of the one or more elements of the I/O module 206 through computer program instructions, for example, software and/or firmware, stored on a memory, for example, the memory 204, and/or the like, accessible to the processing system 202.

The communication module 208 may include several channel interfaces to receive information from a plurality of enterprise interaction channels. Some non-exhaustive examples of the enterprise interaction channels may include a Web channel (i.e., an enterprise Website), a voice channel (i.e., voice-based customer support), a chat channel (i.e., chat support), a native mobile application channel, a social media channel, and the like. Each channel interface may be associated with a respective communication circuitry such as for example, a transceiver circuitry including antenna and other communication media interfaces to connect to a wired and/or wireless communication network. The communication circuitry associated with each channel interface may, in at least some example embodiments, enable transmission of data signals and/or reception of signals from remote network entities, such as Web servers hosting enterprise Websites or a server at a customer support and service center configured to maintain real-time information related to interactions between customers and agents.

In at least one example embodiment, the channel interfaces are configured to receive up-to-date information related to the customer-agent interactions from the enterprise interaction channels. In some embodiments, the information may also be collated from the plurality of devices utilized by the customers. To that effect, the communication module 208 may be in operative communication with various customer touch points, such as electronic devices associated with the customers, Websites visited by the customers, devices used by customer support representatives (for example, voice agents, chat agents, IVR systems, in-store agents, and the like) engaged by the customers, and the like.

The communication module 208 may further be configured to receive information related to customer interactions with agents, such as voice or chat interactions between customers and conversational agents (for example, automated conversational agents or human agents) being conducted using various interaction channels, in real-time. The communication module 208 may provide the received information to the processing system 202. In at least some embodiments, the communication module 208 may include relevant Application Programming Interfaces (APIs) to communicate with remote data-gathering servers associated with such enterprise interaction channels. Moreover, the communication between the communication module 208 and the remote data-gathering servers may be realized over various types of wired and/or wireless networks.

In an embodiment, various components of the apparatus 150, such as the processing system 202, the memory 204, the I/O module 206, and the communication module 208 are configured to communicate with each other via or through a centralized circuit system 210. The centralized circuit system 210 may be various devices configured to, among other things, provide or enable communication between the components (202-208) of the apparatus 150. In certain embodiments, the centralized circuit system 210 may be a central printed circuit board (PCB) such as a motherboard, a main board, a system board, or a logic board. The centralized circuit system 210 may also, or alternatively, include other printed circuit assemblies (PCAs) or communication channel media.

It is noted that the apparatus 150 as illustrated and hereinafter described is merely illustrative of an apparatus that could benefit from embodiments of the invention and, therefore, should not be taken to limit the scope of the invention. It is noted that the apparatus 150 may include fewer or more components than those depicted in FIG. 2. In an embodiment, one or more components of the apparatus 150 may be deployed in a Web Server. In another embodiment, the apparatus 150 may be a standalone component in a remote machine connected to a communication network and capable of executing a set of instructions (sequential and/or otherwise) to facilitate customer-agent interactions using AR. Moreover, the apparatus 150 may be implemented as a centralized system, or, alternatively, the various components of the apparatus 150 may be deployed in a distributed manner while being operatively coupled to each other. In an embodiment, one or more functionalities of the apparatus 150 may also be embodied as a client within devices, such as agents' devices. In another embodiment, the apparatus 150 may be a central system that is shared by or accessible to each of such devices.

The apparatus 150 is depicted to be in operative communication with a database 250. The database 250 is any computer-operated hardware suitable for storing and/or retrieving data, such as, but not limited to, a registry of standard and specialized VAs, a registry of human agents, a plurality of images related to customer concerns, content for overlaying on viewfinder frames to configure AR image frame content, and the like. In at least one embodiment, the database 250 is configured to store a plurality of AR-based workflows. Each AR-based workflow may be configured to provide assistance to users for a specific user objective. It is noted that the user objective may be related to the resolution of a concern, or, to complete a purchase of an enterprise offering. In an illustrative example, the database 250 may store an AR-based workflow capable of providing assistance to a user in setting up a wireless router. In another illustrative example, the database 250 may store an AR-based workflow capable of guiding a user in completing an online purchase of an enterprise product, such as a mobile phone. It is noted that each AR-based workflow is associated with a set of instructions that, when followed, is capable of providing the desired assistance to the users. The relevant instructions from among the set of instructions may be dynamically selected based on the ongoing interaction with the user. For example, the set of instructions for setting up a wireless router may include instructions for different models/versions of wireless routers and, based on the user's input related to a model/version of the wireless router, appropriate instructions from among the set of instructions may be selected for providing assistance to the user.

The database 250 may include multiple storage units such as hard disks and/or solid-state disks in a redundant array of inexpensive disks (RAID) configuration. The database 250 may include a storage area network (SAN) and/or a network-attached storage (NAS) system. In some embodiments, the database 250 is integrated within the apparatus 150. For example, the apparatus 150 may include one or more hard disk drives as the database 250. In other embodiments, the database 250 is external to the apparatus 150 and may be accessed by the apparatus 150 using a storage interface (not shown in FIG. 2). The storage interface is any component capable of providing the processing system 202 with access to the database 250. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processing system 202 with access to the database 250.

In at least one embodiment, the communication module 208 is configured to receive a request from a customer for initiating an interaction with an agent. The customer may utilize a smart electronic device, for example, a device equipped with AR capability, to initiate the request for agent interaction. In an illustrative example, the customer may use a smart electronic device to access an enterprise Website. The customer may request an agent interaction by clicking on a widget or on a hyperlink displayed on the enterprise Website. The widget or the hyperlink may be configured to display text such as ‘Let's Chat’ or ‘Need Assistance, Click Here!’. The customer may click on the widget or the hyperlink to seek assistance. In some example scenarios, the customer may also use the smart electronic device to place a call to a customer care number displayed on the enterprise Website to request an interaction with the agent.

In at least some embodiments, the communication module 208 may be configured to receive such a request for interaction from the customer and forward the request to the processing system 202. The processing system 202 may be configured to use initial interaction handling logic stored in the memory 204 and, in conjunction with the registry of agents stored in the database 250, determine a suitable agent for interacting with the customer. In another embodiment, a high-level intent may be predicted based on the user interaction data accessed from the database 250 associated with the processing system 202. It is noted that the user interaction data indicates information related to present and historical user interactions and the agent capable of handling customers for the predicted intent may be selected from a repository of agents for conducting the interaction with the user. In yet another embodiment, a user persona may be predicted based on the current (i.e., present) and past (i.e., historical) journeys of the customer on the enterprise interaction channels (i.e., information stored in the user interaction data), and an agent more suited to a user persona type may be selected for conducting the interaction with the user. The selected agent may thereafter initiate the interaction with the user.

In an illustrative example, the customer may have initiated a chat interaction with a virtual agent on the enterprise Website. The customer may ask a query to the virtual agent subsequent to the initiation of the chat conversation. In at least one embodiment, the virtual agent may fetch relevant content from the database 250 which would form the response to the query posed by the customer. The response may be provided to the customer on the customer's chat console displayed on the customer's smart electronic device. In some example scenarios, the virtual agent may determine that the customer objective may be met in a better manner using AR. Accordingly, the virtual agent, in conjunction with the apparatus 150, may also be configured to trigger an AR experience on the customer's side. In particular, a display of an option may be facilitated on the electronic device such that the option enables the user to initialize the AR session. More specifically, the apparatus 150 may be configured to include an application triggering option in the virtual agent's response, which may be indicative of the request to trigger the AR experience on the customer's side. In an illustrative example, the processing system 202 of the apparatus 150 may include a hyperlink or a URL in the virtual agent's response, where the hyperlink/URL upon selection is capable of placing an application programming interface (API) call to an AR application in the customer's smart electronic device.

Accordingly, in addition to receiving the response from the virtual agent, a URL or a widget may be displayed on the customer's chat console. The selection of the URL or the widget may cause the AR experience to be triggered. In some embodiments, the processing system 202 is configured to provision an activation message in a text message (for example, a short message service or an instant message) to the customer on the same smart electronic device or a related customer device equipped with AR. The selection of the activation message may be configured to trigger the camera and AR kits ON, which would start the AR experience.

The processing system 202 in the apparatus 150 may also be configured to select an appropriate AR-based workflow from among a plurality of AR-based workflows based on the interaction between the customer and the virtual agent. For example, if the customer's objective is identified (or predicted) to be troubleshooting a product, then an AR-based workflow related to troubleshooting that specific product may be selected from among a plurality of workflows. Further, as explained above, the communication module 208 is configured to capture user interaction data including information related to the customer and the customer's current and past interactions, and relay such information to the processing system 202. The processing system 202 may be configured to extract information related to an electronic device type, a user location, and a user demographic (such as gender, age, ethnicity, language spoken, education level, and economic level) from the user relationship management (URM) data (also, referred to hereinafter interchangeably as customer relationship management (CRM) data) as well as from the customer's current and/or past interaction history. Further, each instruction of the set of instructions associated with the AR-based workflow may be customized by the processing system 202 based, at least in part, on the user relationship management data and the user interaction data.

For example, if an AR-based workflow for setting up a wireless router has been selected and if it is determined from the URM data that the customer is an elderly individual, then instructions that are simple to understand and which are associated with accompanying description are selected from among the set of instructions associated with the AR-based workflow. In another illustrative example, if an AR-based workflow for assisting a customer in purchasing a product is selected and if it is determined that the customer is fond of a particular brand of products, then dynamically generated promotional content such as offers/discounts associated with that brand of products (i.e., determined via analyzing the viewfinder) may be showcased to the customer as part of instructions associated with the AR-based workflow. In yet another illustrative example, if a customer subscribes to National Basketball League (NBA) and is a resident of the Bay area, then messages like ‘Hello <customer>. Hope you are enjoying the Warriors games. Let me help you’ may also be included as part of the interaction to personalize and improve the quality of customer experience.

In at least one embodiment, subsequent to triggering the AR experience, the virtual agent may provide instructions from among the set of instructions associated with the selected AR-based workflow to the customer to resolve the customer's concern. In at least some embodiments, the virtual agent's instructions to resolve the customer concern may be split into smaller intermediary steps. In many example scenarios, the virtual agent's first instruction to the customer is to initiate the AR session and to point the camera to one or more objects in the vicinity of the customer. The viewfinder frame captured by the camera as part of the AR experience may be received by the processing system 202. The processing system 202 may use logic stored in the memory 204 to electronically analyze the viewfinder frame and determine whether the result of the analysis is a success or not. For example, an instruction provided by the virtual agent to the customer may request the customer to point the camera to a reset button of a wireless router. The customer may point the camera to the reset button on the wireless router. The viewfinder frame displayed in the viewfinder of the customer's electronic device subsequent to the pointing of the camera to the reset button may be analyzed by the processing system 202.

For example, the viewfinder frame of the reset button may be compared with stored images of the reset button. If a match between the viewfinder frame and a stored image is identified then the result of the analysis/comparison may be deemed to be successful. If the analysis of the viewfinder frame is deemed to be successful (this may be indicative of the particular instruction being correctly followed by the customer, i.e., the execution status is successful) then the processing system 202 may be configured to identify a subsequent instruction to be provided to the customer to resolve the customer's concern. For example, subsequent to determining that the customer has correctly identified the reset button on the wireless router, the processing system 202 may be configured to identify the next instruction to be performed by the customer. In an illustrative example, the processing system 202 may be configured to generate an AR image frame content by overlaying the viewfinder frame with one or more instructions. For example, a pointer to the reset button may include an instruction to the customer to press the reset button for a few seconds. A subsequent instruction may similarly be overlaid on a viewfinder frame of the wireless router being viewed through the viewfinder of the camera. For example, a pointer to relevant LED lights on the wireless router may instruct the customer to wait for the blinking lights to be steady. Such AR image frame content (i.e., instructions overlaid on the viewfinder frames) may not only facilitate the resolution of the customer's concern but also provide an enriched interaction experience for the customer.

It is noted that if the analysis of a viewfinder frame resulted in a failure (may be indicative of the instruction being incorrectly followed by the customer, i.e., the execution status is unsuccessful) then the processing system 202 may be configured to identify another detailed instruction (from among the set of instructions associated with the selected AR-based workflow) that may enable the customer to follow the instruction easily. For example, if the customer has pointed to a power button instead of the reset button, then the viewfinder frame indicative of the power button may not match the stored images of the reset button. In such a scenario, the result of the analysis/comparison may be deemed to be unsuccessful. In such a scenario, the processing system 202 may be configured to identify a more detailed instruction, such as for example an instruction including a description of the reset button (for example, its color and location), and provide the same to the customer to enable the customer to select the reset button.

It is also noted that the viewfinder frames are directly processed by the processing system 202 and, as such, the viewfinder frames are neither stored nor forwarded to the agent to ensure that the customer's privacy is not compromised.

In at least one embodiment, the processing system 202 is further configured to monitor the progress of the execution of the instructions by the customer and notify the agent of the execution status (hereinafter referred to as ‘status’ for the sake of brevity) of each instruction. If the execution of an instruction has failed, another intermediary instruction to supplement the failed step is generated. More specifically, upon determining that the analysis of a viewfinder frame resulted in a failure then, a set of intermediary instructions for rectifying the unsuccessful execution of the instruction are generated. Further, a display of another AR image frame on the electronic device is facilitated, wherein another AR image frame is generated based, at least in part, on the set of intermediary instructions. After successful completion of the instruction set the interaction may continue to the next stage of the workflow (i.e., workflow related to closing the interaction, receiving feedback, etc.) In at least some embodiments, the entire customer-agent interaction along with the instructions associated with the AR-based workflow used for facilitating the interaction is logged in the database 250. In some embodiments, such logged interactions may be used for refining the instruction sets associated with the AR-based workflows.

In some embodiments, the leveraging of the AR experience by the processing system 202 may also be extended to provide the customers with various promotional content such as offers, product descriptions, discounts, and the like. A similar AR-based workflow as explained above may be followed to provide instructions to the customers. The customer may point to various products in the customer's vicinity and details of the product may be overlaid as part of the AR experience via the generation of the AR image frame based, at least in part, on the promotional content. Further, as explained above, the instruction set may be customized based on customer data such as psychographic segmentation or demography of the user (i.e., user relationship management (URM) data) or device characteristics, or any combination of these features. Further, it is noted that the promotional content shared (such as but not limited to offers, prices, product descriptions, and discounts) with the customer can also be personalized and can be part of the AR experience.

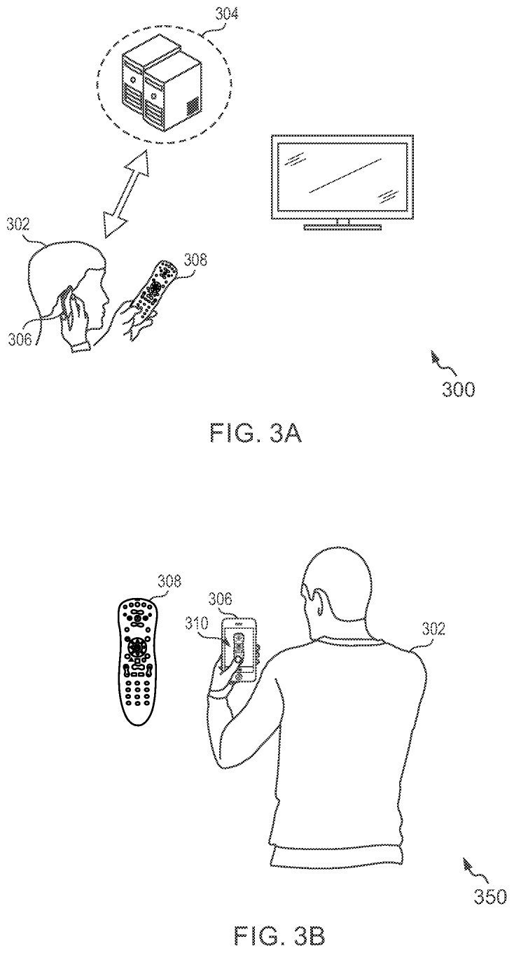

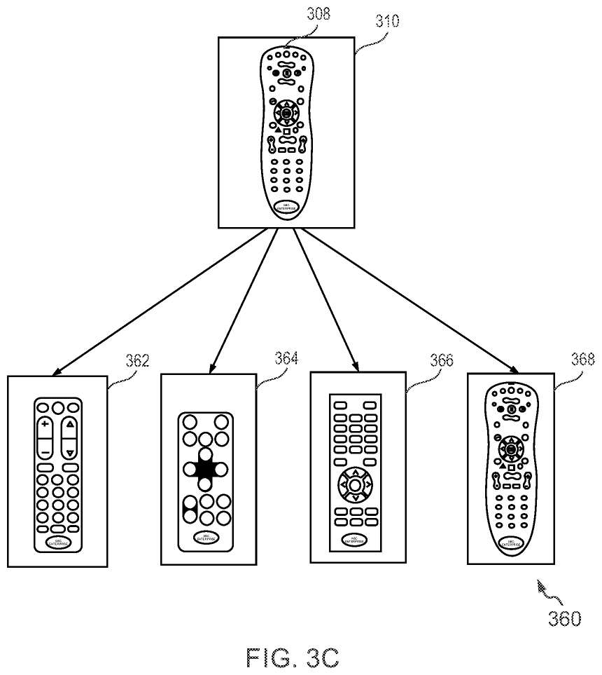

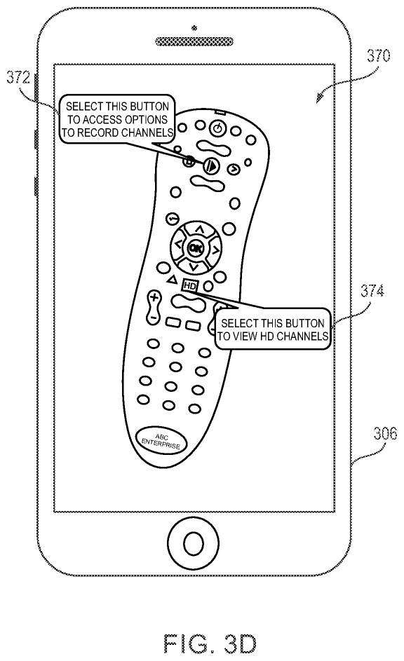

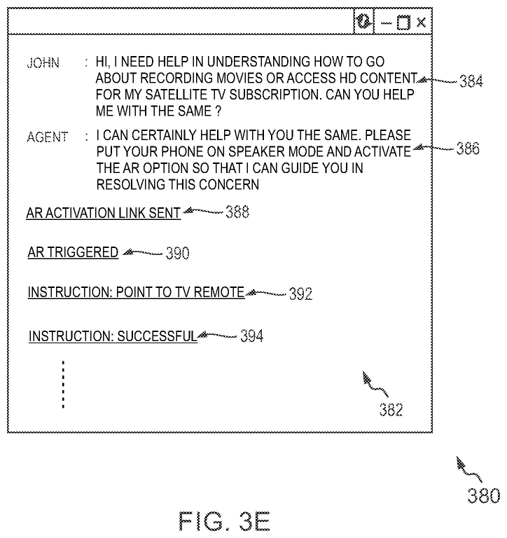

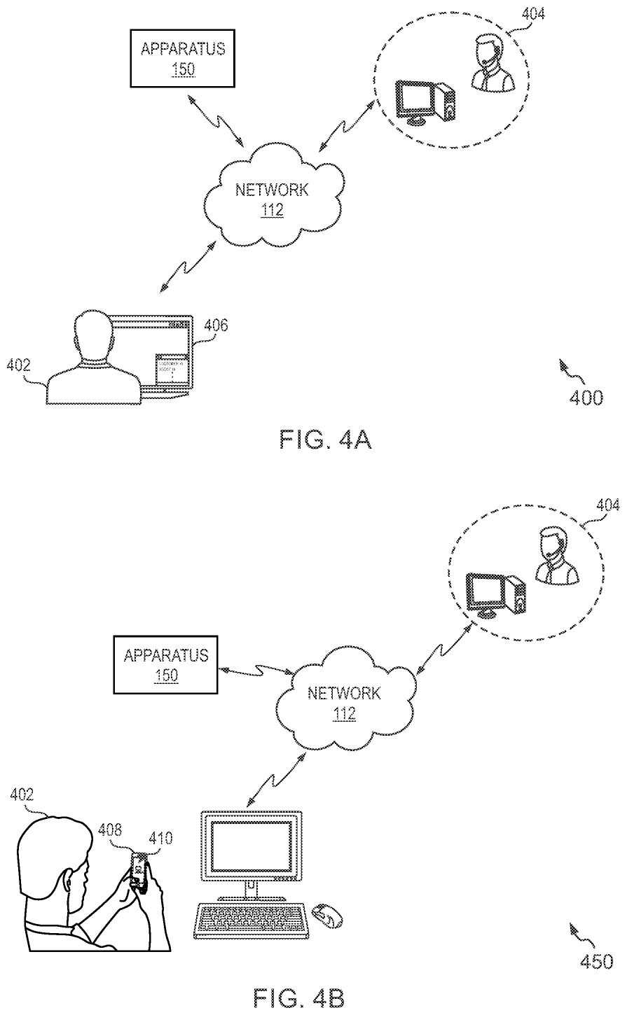

As the customer navigates through the various products the agent (for example, the virtual agent or the human agent) also gets notified of every progress of the customer and the processing system 202 may be configured to inject any dynamic content (such as promotional content) based on the customer experience. In an illustrative example, if a customer is spending more time on a specific product, an offer could be dynamically mentioned in the AR experience. The use of AR by the apparatus 150 to facilitate customer-agent interactions is further explained with reference to FIGS. 3A to 4B.

FIG. 3A shows a representation 300 for illustrating the use of AR in facilitating customer-agent interactions, in accordance with an example embodiment. The representation 300 shows a customer 302 engaged in a voice interaction with an enterprise agent embodied as an interactive voice response (IVR) system 304. The IVR system 304 is hereinafter referred to as a virtual agent 304. In an example scenario, the customer 302 may have an issue in accessing/recording some channels on a Satellite Dish TV transmission. To troubleshoot this concern, the customer 302 may place a call to a customer care center of an enterprise associated with the Satellite Dish TV transmission. The customer 302 may place a call to the customer care center using a smart phone device, hereinafter referred to as a device 306. It is noted that the device 306 is equipped with a camera and includes AR capability.

As explained with reference to FIG. 2, the call may be received by the apparatus 150 (shown in FIG. 2). The processing system 202 of the apparatus 150 may identify an agent from among the repository of agents most suitable to engage in an interaction with the customer 302. In an example scenario, the processing system 202 may select the virtual agent 304 to be most suitable to interact with the customer 302.

The customer 302 may ask a query related to the issue of accessing/recording of certain channels associated with Satellite Dish TV transmission. In response, the virtual agent 304 may respond with an answer ‘I CAN CERTAINLY HELP YOU THE SAME. PLEASE PUT YOUR PHONE ON SPEAKER MODE AND ACTIVATE THE AR OPTION SO THAT I CAN GUIDE YOU IN RESOLVING THIS CONCERN’. In addition to the spoken response, a URL including a button for activating the AR may be provided to the customer 302 on the device 306. It is noted the URL may be provisioned in an enterprise native mobile application installed in the device 306 or by using an SMS/text message means. In response to the instruction from the virtual agent 304, the customer 302 may put the device 306 in speaker mode and select the button in the URL to trigger the AR. In addition to the triggering of the AR experience on the device 306, processing system 202 may also identify a suitable AR-based workflow, such as for example a workflow related to assisting customers with concerns related to the recording of channels on a Satellite Dish TV transmission. The identified AR-based workflow along with the corresponding set of instructions may be used to facilitate the resolution of the customer's query. As explained with reference to FIG. 2, the resolution of the customer's query may be broken down into a plurality of intermediary steps.

In an illustrative example, the customer 302 having enabled the AR may be requested to point the camera to a TV remote 308. The customer 302 may follow the instruction and point the camera to the TV remote 308. Such a customer action is exemplarily shown in FIG. 3B. More specifically, FIG. 3B is a representation 350 showing the customer 302 pointing a camera embedded in the device 306 to the TV remote 308 in response to the instruction from the virtual agent 304 (shown in FIG. 3A), in accordance with an example embodiment. It is noted that the camera is enabled as part of the AR experience triggered by activating the AR application in the device 306. The camera (not shown in FIG. 3B) is configured to capture content capable of being accommodated with a range of the camera's viewfinder. The content captured by the viewfinder is referred to hereinafter as the viewfinder frame. An example viewfinder frame 310 is shown in FIG. 3B. It is noted that, in at least some embodiments, the customer 302 may not have to specifically click a picture of the TV remote 308. As the camera is ON, it may capture content within its range and such content may be streamed to the apparatus 150 in form of the viewfinder frame 310.

In at least one embodiment, the viewfinder frames, such as the viewfinder frame 310, received from the AR application of the device 306 may be analyzed by the processing system 202 of the apparatus 150. In at least one embodiment, the analysis of the viewfinder frames may involve comparison of the viewfinder frames with stored image content i.e., stored images in the database 250 (the database 250 is shown in FIG. 2). As an illustrative example, the database 250 may store images of a variety of TV remotes associated with satellite Dish TV transmission. The viewfinder frame 310 may be compared with images of TV remotes as exemplarily depicted in FIG. 3C.

More specifically, FIG. 3C shows a representation 360 for illustrating a comparison of the viewfinder frame 310 with a plurality of images of TV remotes, in accordance with an example embodiment. As explained with reference to FIG. 3B, the viewfinder frame 310 includes a visual of the TV remote 308. Further, as explained with reference to FIG. 3B, the processing system 202 of the apparatus 150 is configured to receive the viewfinder frame 310 and electronically process/analyze the viewfinder frame 310. In some embodiments, the viewfinder frames captured as part of the AR experience may be processed or analyzed to extract information, which may then be used to determine the next instruction. For example, if the comparison of the viewfinder frame 310 with stored images of TV remotes such as images 362, 364, 366, and 368 results in a match (for instance, the TV remote 308 in the viewfinder frame 310 is similar to the TV remote included in the image 368), then the processing system 202 may be configured to determine that a set-top box associated with the customer supports recording/accessing certain channels or not. More specifically, if the TV remote 308 includes buttons for recording, pausing live TV, and other such buttons, then the set-top box provided to the customer as part of the customer's subscription may include in-built storage to facilitate the recording of channels. Similarly, if the TV remote 308 includes buttons like ‘favorite’, ‘High Definition’ etc., then it may be inferred that the customer's TV supports high definition (HD) or high-resolution channels and the customer 302 is eligible to access HD channels. Accordingly, the analysis of the viewfinder frame 310 may facilitate the extraction of information, such as the type of TV remote available to the customer 302, which in turn may enable inference of whether the customer 302 can record/access certain TV channels or not.

It is noted that the analysis of the viewfinder frames may not be limited to the objective of extracting information. In some embodiments, the viewfinder frames captured as part of the AR experience may be processed or analyzed to determine if the instruction is being correctly followed by a customer or not. For example, if the customer 302 was requested to select the ‘voice command’ button on the TV remote 308, then the camera pointed to the TV remote 308 while the customer 302 is pressing the voice command button may enable the processing system 202 to determine if the customer 302 is aware of which button enables activation of the voice command instruction option.

In at least one embodiment, the result of the analysis of the viewfinder frames, or more specifically, the comparison of viewfinder frames with stored image content may determine the next instruction to be provided to the customer 302. For example, if the viewfinder frame 310 of the TV remote 308 did not match any image of the TV remote that facilitates recording/accessing channels, then instructions related to upgrading the subscription may be provided to the customer 302. Similarly, if the TV remote 308 was correctly identified and it was determined that the TV remote 308 does not include the buttons for recording/accessing certain channels, then instructions related to upgrading the subscription may be provided to the customer 302. However, if the TV remote 308 was correctly identified and it was determined that the TV remote 308 does include the buttons for recording/accessing certain channels, then instructions related to how to record/access the desired channels may be overlaid on the viewfinder frame 310 to generate AR image frame content. Such content may then be displayed to the customer 302 on the display screen of the device 306 associated with the customer 302 as shown in FIG. 3D.

Referring now to FIG. 3D, an example AR image frame content 370 displayed on a display screen of the device 306 of the customer 302 is shown, in accordance with an example embodiment. As can be seen, the AR image frame content 370 is generated by overlaying the viewfinder frame 310 with instructions. More specifically, the AR image frame content 370 is depicted to include two pointers 372 and 374. The pointer 372 is depicted to point to a button displaying a symbol indicative of a record option and is associated with an instruction ‘SELECT THIS BUTTON TO ACCESS OPTIONS TO RECORD CHANNELS’. Similarly, the pointer 374 is depicted to point to a button displaying a symbol indicative of an option to access HD channels and is associated with an instruction ‘SELECT THIS BUTTON TO VIEW HD CHANNELS’.

If the customer 302 (not shown in FIG. 3D) presses the button corresponding to the record option, then the camera may capture this activity and a corresponding viewfinder frame may be transmitted to the processing system 202. The processing system 202 may be configured to analyze this viewfinder frame and may identify the next set of instructions related to the selection of individual options for recording channels (such as setting time for recording channels, etc.). Thereafter, similar AR image frame content (i.e., viewfinder image overlaid with instructions) may be displayed on the display screen of the device 306.

Similarly, if the customer 302 presses the button corresponding to the HD channel access, then the camera may capture this activity and a corresponding viewfinder frame may be transmitted to the processing system 202. The processing system 202 may be configured to analyze this viewfinder frame and may identify the next set of instructions related to ‘accessing HD channels’. The identified instructions may be overlaid on the viewfinder frame 310 and displayed as AR image frame content on the display screen of the device 306.

In at least some embodiments, the processing system 202 is configured to monitor the progress of the instruction set and notify the virtual agent 304 on the agent's console on the success or failure of a particular instruction. Further, as explained above, if the step was unsuccessful, the processing system 202 is configured to generate another intermediary instruction set to supplement the failed step. After the successful completion of the instruction set, the interaction may continue to the next stage of the workflow. An example UI of the agent's chat console showing the notifications provided by the processing system 202 is shown in FIG. 3E.

FIG. 3E shows an example representation of an agent console 380 for illustrating the notifications provide by the apparatus 150 of FIG. 2, in accordance with an example embodiment. The agent console 380 corresponds to the virtual agent 304 engaged in an interaction with the customer 302 for resolving the customer issue related to accessing/recording certain channels associated with the Satellite Dish TV transmission. It is noted that the agent console 380 is depicted herein for visualization purposes and that the virtual agents may not be typically associated with dedicated display screens or electronic devices for displaying the agent consoles, such as the agent console 380. In such scenarios, the virtual agents may be configured to: receive inputs from the customers, perform necessary NLP and interpretation of the customer inputs, fetch answers from the database (such as the database 250), and provision the answers to the customers. More specifically, the VAs may be configured to conduct the interactions with the customers as a series of instruction-driven operations and thereby preclude the need for a dedicated console.

The agent console 380 is depicted to display textual transcript 382 of the voice interaction between the customer 302 and the virtual agent 304. The agent utterances during the interaction are depicted to be tagged with the label ‘AGENT’, whereas the customer utterances during the interaction are depicted to be tagged with the label ‘JOHN’ for illustration purposes. As an example, the customer ‘JOHN’ is depicted to have initiated an interaction at 384 with an utterance: ‘HI, I NEED HELP IN UNDERSTANDING HOW TO GO ABOUT RECORDING MOVIES OR ACCESS HD CONTENT FOR MY SATELLITE TV SUBSCRIPTION. CAN YOU HELP ME WITH THE SAME?’ The agent is depicted to have responded at 386 with an utterance: ‘I CAN CERTAINLY HELP YOU WITH THE SAME. PLEASE PUT YOUR PHONE ON SPEAKER MODE AND ACTIVATE THE AR OPTION SO THAT I CAN GUIDE YOU IN RESOLVING THIS CONCERN.’.

An URL with a button to trigger the AR option may then be provided to the customer 302. The delivery status of the URL and subsequent selection of the URL by the customer 302 is notified to the virtual agent 304 as shown in notifications 388 and 390. Further, as explained above, an appropriate AR-based workflow may be selected and instructions related to the AR-based workflow provided to the customer for assisting the customer 302. The virtual agent 304 may be kept informed about the instructions provided to the customer and the subsequent execution status of the instruction. For example, providing the instruction related to pointing the camera to the TV remote 308 and its subsequent execution status may be notified to the virtual agent 304 as shown using notifications 392 and 394. Accordingly, the virtual agent 304 may be notified of the progress of the instruction set in substantially real-time. As explained above, if the step was unsuccessful, the processing system 202 is configured to generate another intermediary instruction set to supplement the failed steps.

It is noted that the leveraging of the AR by the apparatus 150 in customer-agent interactions has been explained above with reference to a voice interaction between a customer and a virtual agent (i.e., an IVR). However, the use of AR in customer-agent interactions is not limited to the examples described herein. Indeed, the apparatus 150 is configured to use the AR in similar manner in interactions involving human agents and interactions conducted over other mediums such as a chat medium, a native mobile application medium, and the like. Moreover, the use of AR in customer-agent interactions may not be limited to resolving customer concerns. In some example scenarios, the AR may be used to provide the customers with various offers, product descriptions, discounts, and the like. An example use of AR for such a purpose is explained next with reference to FIGS. 4A and 4B.

FIG. 4A shows a representation 400 for illustrating the use of AR for facilitating customer-agent interactions, in accordance with another example embodiment. The representation 400 shows a customer 402 engaged in a chat interaction with a human agent 404. In an example scenario, the customer 402 may be interested in purchasing a new laptop and may have visited an Ecommerce site using a personal computer 406 to view options for purchasing the laptop. The customer 402, having evaluated the specifications of various laptop models, may have a query regarding the available options to make payment. Accordingly, the customer 402 may initiate an interaction, such as for example, a chat interaction with the human agent 404 of the enterprise on the Website itself. The customer 402 may also be associated with a smart phone device (shown in FIG. 4B), which is equipped with a camera and includes AR capability.

In at least one embodiment, the request for chat interaction from the customer 402 may be received by the apparatus 150 over the network 112. The processing system 202 (shown in FIG. 2) of the apparatus 150 may identify an agent from among the repository of agents most suitable to engage in the chat interaction with the customer 402. In an example scenario, the processing system 202 may select the human agent 404 to be most suitable to interact with the customer 402.

Subsequent to the initiation of the interaction, the customer 402 may convey the desire to purchase a Brand ‘X’ model of the laptop sold by an enterprise ‘Y’ to the human agent 404. Further, the customer 402 may ask regarding the available payment options for purchasing the laptop. In an example scenario, the enterprise ‘Y’ may have an ongoing exchange offer on the sale of laptops, and the human agent 404 may determine that the offer may be of interest to the customer 402. Accordingly, the human agent 404 may wish to know the model number of the personal computer 406 as well as the product specification (for example, the processor chip, the RAM capacity, the hard disk capacity, screen size, etc.) of the personal computer 406 to determine if the customer 402 is eligible for the exchange offer or not. To that effect, the human agent 404 may request the customer 402 to activate the AR on a device associated with the customer 402. As explained above, the customer 402 may be associated with a smartphone device 408 (shown in FIG. 4B), hereinafter referred to as a device 408. In at least one embodiment, an AR activation link may be presented to the customer 402 on the device 408. The customer 402 may activate the AR on the device 408. As explained, the processing system 202 of the apparatus 150 may also select an AR-based workflow related to the customer's objective, for example an AR-based workflow capable of guiding the customer to provide the information related to customer's device. The instruction set associated with the selected AR-based workflow may then be provided in a step-by-step manner to the customer 402 and the customer 402 may proceed to follow the instructions provided by the human agent 404.

In one example scenario, an initial instruction may request the customer 402 to point a camera to the personal computer 406. The customer 402 having triggered the AR on the device 408 may point the camera of the device 408 to capture image frame(s) related to the personal computer 406. Such a scenario is depicted in FIG. 4B. More specifically, FIG. 4B is a representation 450 showing the customer 402 pointing the camera embedded in the device 408 to the personal computer 406 in response to the instruction associated with an AR-based workflow, in accordance with an example embodiment. It is noted that the camera is enabled as part of the AR experience triggered by activating the AR application in the device 408. The camera (not shown in FIG. 4B) may cause the display of a visual of the personal computer 406 on a display screen of the device 408. The visual of the personal computer 406 displayed in the viewfinder of the camera is hereinafter referred to as viewfinder frame 410. It is noted that, in at least some embodiments, the customer 402 may not have to specifically click a picture of the personal computer 406. The camera being ON may capture content within its range and such content may be streamed to the apparatus 150.

In at least one embodiment, the processing system 202 of the apparatus 150 may electronically analyze the viewfinder frame 410 and determine a make and model of the personal computer 406 (such as for example, if it is a Macintosh® or a Windows® PC). Based on the said determination, subsequent instructions may be provided to the customer 402, such as for example, how to access the configuration page. The instructions may be overlaid on the viewfinder image 410 to configure the AR image frame content. The generation of AR image frame content may be performed as explained with reference to FIG. 3D and is not explained again herein.

The camera may capture customer movements and the subsequent display changes on the display screen of the personal computer 406. If an instruction is not being correctly followed, the instruction set may be refined to provide necessary course correction. The configuration page once accessed may be streamed as a viewfinder frame to the processing system 202, which may then be configured to extract product specifications (for example, the processor chip, the RAM capacity, the hard disk capacity, screen size, etc.). Such extraction of information precludes the need for back-and-forth instructions from the human agent 404 to the customer 402. Moreover, the customer 402 is spared the burden of answering all the queries put forth by the human agent 404. In the aforementioned example, on learning the product specification of the personal computer 406, the processing system 202 may identify if the customer 402 qualifies for the exchange offer of exchanging an old computer with a new laptop. If it is determined that the customer 402 qualifies for the exchange offer, applicable discounts may be conveyed to the customer 402. Moreover, the human agent 404 may explain to the customer 402 ‘how to pay the remaining balance amount’. The leveraging of AR in such a manner not only resolves the customer concern but also helps in providing an enriched customer experience to the customers.

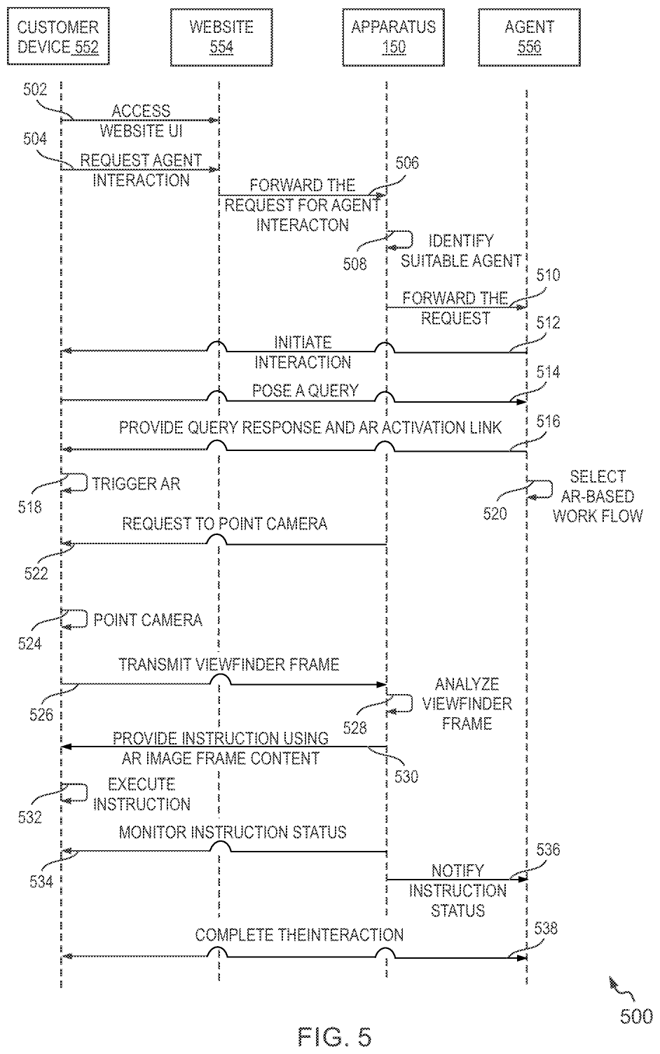

FIG. 5 shows a sequence flow for illustrating the facilitation of customer-agent interactions using AR, in accordance with an example embodiment. The use of AR for facilitating customer-agent interactions is explained with reference to an agent interaction initiated on a Website 554 by a customer. However, as explained with reference to FIGS. 3A to 4B, the customer-agent interactions may be initiated over a voice call interaction with a voice agent (such as a human agent or an IVR). Moreover, it is noted that the terms customer and customer device are used interchangeably hereinafter. The sequence flow 500 starts at 502.

At 502, a customer uses a customer device 552 to access a user interface (UI) associated with the website 554 of an enterprise.

At 504, the customer requests an agent interaction on the Website 554. As explained with reference to FIG. 1, many enterprise websites may display widgets or buttons associated with text like ‘Let's talk’ or ‘Speak with our Agent’. The customer may select such a widget or a button to provide a request for agent interaction.

At 506, the website 554 forwards the request for agent interaction to the apparatus 150, which is explained with reference to FIG. 2 to FIG. 5B.

At 508, the apparatus 150 identifies a suitable agent for interacting with the customer. The identification of the suitable agent may be performed as explained with reference to FIG. 2 and is not explained again herein.

At 510, the request for interaction is forwarded to the suitable agent, exemplarily depicted to be an agent 556, by the apparatus 150.

At 512, the agent 556 initiates an interaction with the customer. More specifically, the agent 556 may cause the display of a chat console on the customer device 552 to initiate the interaction.

At 514, the customer poses a query to the agent 556. At 516, the agent 556 provides a query response and an augmented reality (AR) activation link to the customer.

At 518, the customer may select the AR activation link to trigger the AR application (hereinafter referred to as ‘AR’).

At 520, the apparatus 150 selects an AR-based workflow based on the agent interaction with the customer. The AR-based workflow is associated with a set of instructions.

At 522, the apparatus 150 instructs the customer to point the camera in the customer device 552 to one or more objects, as per the instruction in the AR-based workflow.

At 524, the customer points the camera to the one or more objects as per instruction from the apparatus 150.

At 526, viewfinder frame is transmitted to the apparatus 150 from the customer device 552.

At 528, the apparatus 150 analyzes the viewfinder frame. The analysis of the viewfinder frame may be performed as explained with reference to FIGS. 2 to 4B and is not explained again herein.

At 530, the apparatus 150 provides instruction using AR image frame content to the customer. The generation of the AR image frame content may be performed as explained in FIG. 3D and is not explained again herein.

At 532, the customer executes the instruction. At 532, the apparatus 150 monitors the status of the executed instruction.

At 536, the apparatus 150 notifies the instruction status to the agent 556.

The steps 530-536 may be repeated till all the instructions for resolving the customer concern are executed by the customer 552. At 538, the agent 556 interacts with the customer to confirm the status of the interaction (whether the concern was resolved successfully or not) and thereafter completes the interaction. In at least some embodiments, the entire customer-agent interaction along with the instructions associated with the AR-based workflow used for facilitating the interaction is logged in the database 250 (shown in FIG. 2). In some embodiments, such logged interactions may be used for refining the instruction sets associated with the AR-based workflows. The sequence flow 500 ends at 538.

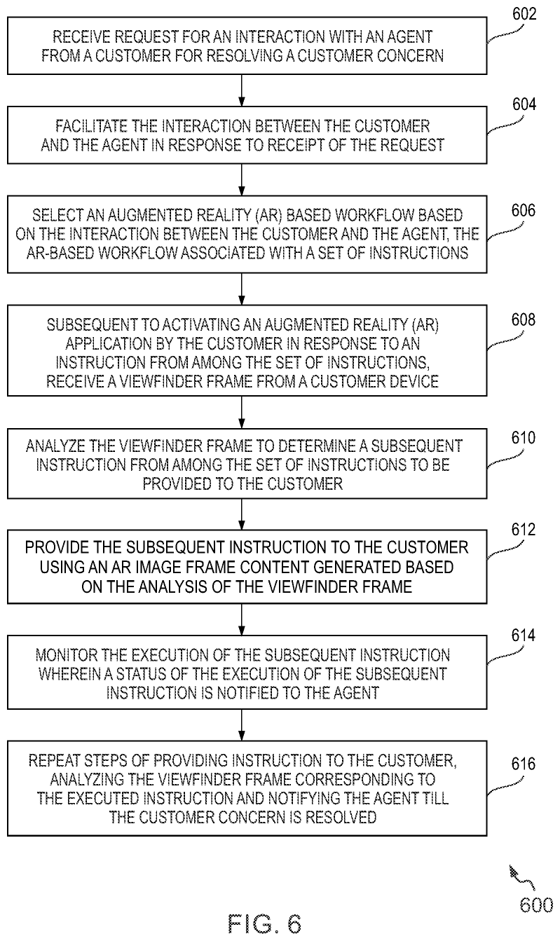

A method for facilitating agent-customer interactions using AR is explained next with reference to FIG. 6.

FIG. 6 shows a flow diagram of a method 600 for facilitating customer-agent interactions using AR, in accordance with an example embodiment. The various steps and/or operations of the flow diagram, and combinations of steps/operations in the flow diagram, may be implemented by, for example, hardware, firmware, a processor, circuitry and/or by an apparatus such as the apparatus 150 explained with reference to FIGS. 1 to 5 and/or by a different device associated with the execution of software that includes one or more computer program instructions. The method 600 starts at operation 602.

At operation 602 of the method 600, a request for an interaction with an agent is received from a customer for a resolving a customer concern.

At operation 604 of the method 600, the interaction is facilitated between the customer and the agent in response to receipt of the request.

At operation 606 of the method 600, an AR-based workflow is selected based on the interaction between the customer and the agent. The AR-based workflow is associated with a set of instructions.

At operation 608 of the method 600, a viewfinder frame is received from a customer device subsequent to activating an AR application by the customer in response to an instruction from among the set of instructions.

At operation 610 of the method 600, the viewfinder frame is analyzed to determine a subsequent instruction from among the set of instructions to be provided to the customer.

At operation 612 of the method 600, the subsequent instruction is provided to the customer using an AR image frame content generated based on the analysis of the viewfinder frame.

At operation 614 of the method 600, the execution of the subsequent instruction is monitored, wherein a status of the execution of the subsequent instruction is notified to the agent.

At operation 616 of the method 600, steps of providing instruction to the customer, electronically analyzing the viewfinder frame corresponding to the executed instruction and notifying the agent are repeated till the customer concern is resolved. The method 600 ends at operation 616.

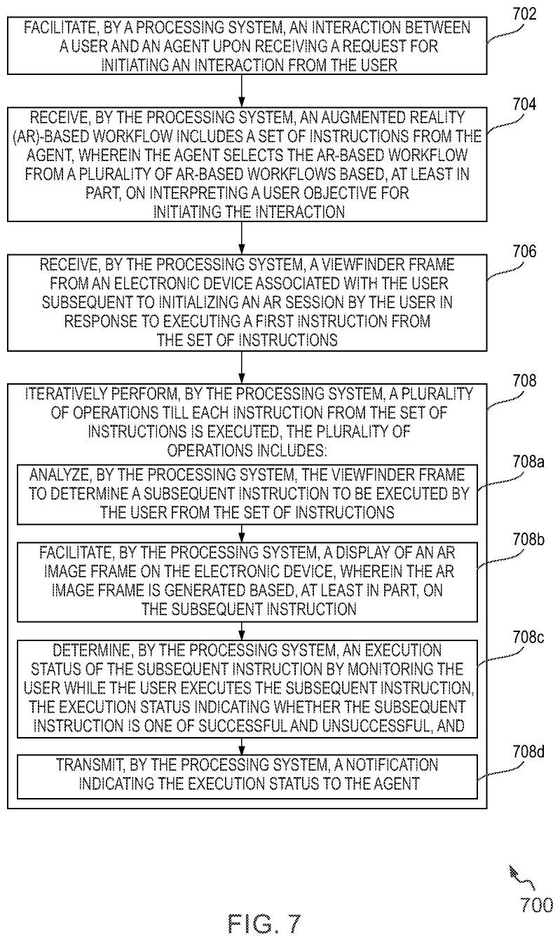

FIG. 7 shows a flow diagram of a method 700 for facilitating an interaction between a user and an agent using AR, in accordance with an example embodiment. The various steps and/or operations of the flow diagram, and combinations of steps/operations in the flow diagram, may be implemented by, for example, hardware, firmware, a processor, circuitry and/or by an apparatus such as the processing system 202 of the apparatus 150 explained with reference to FIGS. 2 to 6 and/or by a different device associated with the execution of software that includes one or more computer program instructions. The method 700 starts at operation 702.

At operation 702 of the method 700 includes facilitating, by a processing system 202, an interaction between a user and an agent upon receiving a request for initiating an interaction from the user.

At operation 704 of the method 700 includes receiving, by the processing system 202, an augmented reality (AR)-based workflow including a set of instructions from the agent. The agent selects the AR-based workflow from a plurality of AR-based workflows based, at least in part, on interpreting a user objective for initiating the interaction.

At operation 706 of the method 700 includes receiving, by the processing system 202, a viewfinder frame from an electronic device (such as electronic devices 120a, and 120b) associated with the user subsequent to initializing an AR session by the user in response to executing a first instruction from the set of instructions.

At operation 708 of the method 700 includes iteratively performing, by the processing system 202, a plurality of operations (708a-708d) till each instruction from the set of instructions is executed.

At operation 708a of the method 700 includes analyzing, by the processing system 202, the viewfinder frame to determine a subsequent instruction to be executed by the user from the set of instructions.

At operation 708b of the method 700 includes facilitating, by the processing system 202, a display of an AR image frame on the electronic device. The AR image frame is generated based, at least in part, on the subsequent instruction.

At operation 708c of the method 700 includes determining, by the processing system 202, an execution status of the subsequent instruction by monitoring the user while the user executes the subsequent instruction. The execution status indicating whether the subsequent instruction is one of successful and unsuccessful.

At operation 708d of the method 700 includes transmitting, by the processing system 202, a notification indicating the execution status to the agent.

Various embodiments disclosed herein provide numerous advantages. More specifically, the embodiments disclosed herein suggest techniques for leveraging AR to solve customer problems and also improve the quality of interaction experience afforded to the customers. As explained with reference to various embodiments, the AR can be leveraged to not only solve customer concerns but also provide offers, discounts, product descriptions to the customer. Using the AR, the agent is provided with feedback on whether the instructions are correctly being followed by the customer or not, resulting in the customer's concerns being resolved much faster and in a logical manner, while precluding the need to have back-and-forth communication between the agent and the customer. As the customer experience is improved, the churn of customers may be reduced and, in some cases, the sale of the enterprise products may also be improved on account of satisfied customers.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I/We claim:

1. A computer-implemented method, the comprising:
facilitating, by a processing system, an interaction between a user and an agent upon receiving a request for initiating an interaction from the user;
receiving, by the processing system, an augmented reality (AR)-based workflow comprising a set of instructions from the agent, wherein the agent selects the AR-based workflow from a plurality of AR-based workflows based, at least in part, on interpreting a user objective for initiating the interaction;
receiving, by the processing system, a viewfinder frame from an electronic device associated with the user subsequent to initializing an AR session by the user in response to executing a first instruction from the set of instructions; and
iteratively performing, by the processing system, a plurality of operations till each instruction from the set of instructions is executed, the plurality of operations comprising:
electronically analyzing, by the processing system, the viewfinder frame to determine a subsequent instruction to be executed by the user from the set of instructions,
facilitating, by the processing system, a display of an AR image frame on the electronic device, wherein the AR image frame is generated based, at least in part, on the subsequent instruction,
determining, by the processing system, an execution status of the subsequent instruction by monitoring the user while the user executes the subsequent instruction, the execution status indicating whether the subsequent instruction is one of successful and unsuccessful, and
transmitting, by the processing system, a notification indicating the execution status to the agent.

2. The computer-implemented method of claim 1, further comprising:
facilitating, by the processing system, a display of an option on the electronic device, the option enabling the user to initialize the AR session.

3. The computer-implemented method of claim 1, further comprising:
accessing, by the processing system, user interaction data from a database associated with the processing system, the user interaction data indicating information related to present and historical user interactions;
predicting, by the processing system, a user intent and a user persona based, at least in part, on the user interaction data; and
selecting, by the processing system, the agent from a repository of agents based, at least in part, on the user intent and the user persona.

4. The computer-implemented method of claim 1, further comprising:
accessing, by the processing system, user relation management data and user interaction data from a database associated with the processing system, the user relation management data comprising information related to an electronic device type, a user location, and a user demographic; and
customizing, by the processing system, each instruction of the set of instructions based, at least in part, on the user relationship management data and the user interaction data.

5. The computer-implemented method of claim 1, wherein electronically analyzing the viewfinder frame further comprises:
accessing, by the processing system, a plurality of images from a database associated with the processing system;
comparing, by the processing system, the viewfinder frame with the plurality of images; and
upon determining a match between the viewfinder and an image from the plurality of images, determining, by the processing system, the subsequent instruction from the set of instructions based, at least in part, on the image.

6. The computer-implemented method of claim 1, wherein generating the AR image frame further comprises:
dynamically determining, by the processing system, a promotional content based, at least in part, on the viewer frame; and
generating, by the processing system, the AR image frame based, at least in part, on the promotional content.

7. The computer-implemented method of claim 6, wherein generating the AR image frame further comprises:
overlaying, by the processing system, the subsequent instruction on the viewfinder frame.

8. The computer-implemented method of claim 1, further comprising:
upon determining that the execution status is unsuccessful generating, by the processing system, a set of intermediary instructions for rectifying the unsuccessful execution of the subsequent instruction; and
facilitating, by the processing system, a display of another AR image frame on the electronic device, wherein the another AR image frame is generated based, at least in part, on the set of intermediary instructions.

9. The computer-implemented method of claim 1, wherein the agent comprises at least one of a human and a virtual agent.

10. An apparatus, comprising:
at least one processor; and
a memory having stored therein machine executable instructions, that when executed by the at least one processor, cause the apparatus, at least in part, to:
facilitate an interaction between a user and an agent upon receiving a request for initiating an interaction from the user;
receive an augmented reality (AR)-based workflow comprising a set of instructions from the agent, wherein the agent selects the AR-based workflow from a plurality of AR-based workflows based, at least in part, on interpreting a user objective for initiating the interaction;
receive a viewfinder frame from an electronic device associated with the user subsequent to initializing an AR session by the user in response to executing a first instruction from the set of instructions; and
iteratively perform a plurality of operations till each instruction from the set of instructions is executed, the plurality of operations comprising:
electronically analyze the viewfinder frame to determine a subsequent instruction to be executed by the user from the set of instructions,
facilitate a display of an AR image frame on the electronic device, wherein the AR image frame is generated based, at least in part, on the subsequent instruction,
determine an execution status of the subsequent instruction by monitoring the user while the user executes the subsequent instruction, the execution status indicating whether the subsequent instruction is one of successful and unsuccessful, and
transmit a notification indicating the execution status to the agent.

11. The apparatus of claim 10, wherein the apparatus is further caused, at least in part, to:
facilitate a display of an option on the electronic device, the option enabling the user to initialize the AR session.

12. The apparatus of claim 10, wherein the apparatus is further caused, at least in part, to:
access user interaction data from a database associated with the apparatus, the user interaction data indicating information related to present and historical user interactions;
predict a user intent and a user persona based, at least in part, on the user interaction data; and
select the agent from a repository of agents based, at least in part, on the user intent and the user persona.

13. The apparatus of claim 10, wherein the apparatus is further caused, at least in part, to:
access user relation management data and user interaction data from a database associated with the apparatus, the user relation management data comprising information related to an electronic device type, a user location, and a user demographic; and
customize each instruction of the set of instructions based, at least in part, on the user relationship management data and the user interaction data.

14. The apparatus of claim 10, wherein to electronically analyze the viewfinder, the apparatus is further caused, at least in part, to:
access a plurality of images from a database associated with the apparatus;
compare the viewfinder frame with the plurality of images; and
upon determining a match between the viewfinder and an image from the plurality of images, determine the subsequent instruction from the set of instructions based, at least in part, on the image.

15. The apparatus of claim 10, wherein to generate the AR image frame, the apparatus is further caused, at least in part, to:
dynamically determine a promotional content based, at least in part, on the viewer frame; and
generate the AR image frame based, at least in part, on the promotional content.

16. The apparatus of claim 15, wherein to generate the AR image frame, the apparatus is further caused, at least in part, to:
overlay the subsequent instruction on the viewfinder frame.

17. The apparatus of claim 10, wherein the apparatus is further caused, at least in part, to:
upon determining that the execution status is unsuccessful generate a set of intermediary instructions for rectifying the unsuccessful execution of the subsequent instruction; and
facilitate a display of another AR image frame on the electronic device, wherein the another AR image frame is generated based, at least in part, on the set of intermediary instructions.

18. A non-transitory computer-readable storage medium comprising computer-executable instructions that, when executed by at least a processor of an apparatus, cause the apparatus to perform a method comprising:
facilitating an interaction between a user and an agent upon receiving a request for initiating an interaction from the user;
receiving an augmented reality (AR)-based workflow comprising a set of instructions from the agent, wherein the agent selects the AR-based workflow from a plurality of AR-based workflows based, at least in part, on interpreting a user objective for initiating the interaction;
receiving a viewfinder frame from an electronic device associated with the user subsequent to initializing an AR session by the user in response to executing a first instruction from the set of instructions; and
iteratively performing a plurality of operations till each instruction from the set of instructions is executed, the plurality of operations comprising:
electronically analyzing the viewfinder frame to determine a subsequent instruction to be executed by the user from the set of instructions,
facilitating a display of an AR image frame on the electronic device, wherein the AR image frame is generated based, at least in part, on the subsequent instruction,
determining an execution status of the subsequent instruction by monitoring the user while the user executes the subsequent instruction, the execution status indicating whether the subsequent instruction is one of successful and unsuccessful, and
transmitting a notification indicating the execution status to the agent.

19. The non-transitory computer-readable storage medium of claim 18, wherein the method further comprises:
accessing user interaction data from a database associated with the apparatus, the user interaction data indicating information related to present and historical user interactions;
predicting user intent and a user persona based, at least in part, on the user interaction data; and
selecting the agent from a repository of agents based, at least in part, on the user intent and the user persona.

20. The non-transitory computer-readable storage medium of claim 18, wherein the method further comprises:
upon determining that the execution status is unsuccessful generating a set of intermediary instructions for rectifying the unsuccessful execution of the subsequent instruction; and
facilitating a display of another AR image frame on the electronic device, wherein the another AR image frame is generated based, at least in part, on the set of intermediary instructions.
